(19) United States
(12) Patent Application Publication
(10) Pub. No.: US 2026/0348304 A1
(43) Pub. Date: Nov. 5, 2026

(54) DEVICE FOR SUSPENDING AN EQUIPMENT ITEM FOR A TURBOMACHINE ON A TURBOMACHINE ENGINE STRUCTURE

(71) Applicant: SAFRAN HELICOPTER ENGINES, BORDES (FR)

(72) Inventors: Antoine Bernard CHRISTOPHE, MOISSY-CRAMAYEL (FR); Mathieu Michel Jean-Baptiste PACCINI, MOISSY-CRAMAYEL (FR); Vincent TROUILHET, MOISSY-CRAMAYEL (FR); Boris Jean René MILLET, MOISSY-CRAMAYEL (FR)

(21) Appl. No.: 19/118,833

(22) PCT Filed: Oct. 20, 2023
(86) PCT No.: PCT/FR2023/051645

§ 371 Date: Apr. 7, 2025

(30) Foreign Application Priority Data
Oct. 28, 2022 (FR) FR2211327
Oct. 28, 2022 (FR) FR2211328

(51) Int. Cl. F01D 25/28

(52) U.S. Cl. CPC F01D 25/28

(57) ABSTRACT

An assembly of a turbomachine engine structure extending along a first axis, at least one equipment item, and a suspension device for suspending the equipment item from the engine structure while being offset along the direction of at least a second axis perpendicular to the first axis. The suspension device includes at least six support rods connecting the equipment item to the engine structure in a statically determinate manner; at least one safety rod connecting the equipment item to the engine structure, the safety rod being configured to have a lower mechanical load than a mechanical load of each of the support rods.

### TECHNICAL FIELD

The present description relates to an assembly comprising a turbomachine engine structure, at least one equipment item, and a suspension device for suspending the equipment item from the engine structure.

### PRIOR ART

An airplane or helicopter engine comprises a turbomachine surrounded by a casing that can carry one or more equipment items, for example a heat exchanger or electrical equipment such as computing, control, and/or power units, each of these equipment items being fixed to the casing by means of a suspension device.

There is a risk of these equipment items detaching, which constitutes a critical event because these relatively heavy equipment items may in turn strike and destroy the casing and/or destroy elements essential to the integrity of the engine or aircraft.

The invention aims to provide a solution that ensures increased safety (known as “fail-safe”) and easy assembly.

### SUMMARY

An assembly is proposed comprising a turbomachine engine structure extending along a first axis, at least one equipment item, and a suspension device for suspending the equipment item from the engine structure while being offset along the direction of at least a second axis perpendicular to the first axis, the suspension device comprising:
at least six support rods connecting the equipment item to the engine structure in a statically determinate manner;
at least one safety rod connecting the equipment item to the engine structure, the safety rod being configured to have a lower mechanical load than a mechanical load of each of the support rods.

Thus, in the event of failure of one of the support rods, the safety rod mechanically participates in suspending the equipment item from the engine structure while avoiding any substantial movement of the equipment item relative to the engine structure or a mechanical overloading of the other support rods. The device therefore provides increased safety with redundancy (“fail-safe”).

When there is no failure of the support rods, the mechanical stresses exerted on the safety rod remain less than or equal to 50% of the mechanical stresses exerted on the support rods. In other words, the safety rod can be differentiated from the support rods in that the maximum stress exerted on the safety rod is less than or equal to 50% of the maximum stress exerted on each of the support rods.

The engine structure may comprise at least a casing, a first engine bracket, and a second engine bracket, the first engine bracket and the second engine bracket each being connected to the casing, the safety rod connecting the first engine bracket to a first upper equipment attachment point of the equipment item.

Said at least six support rods may comprise:
a first support rod and a second support rod connecting the first engine bracket to a first lower equipment attachment point of the equipment item, the first support rod and the second support rod each having a respective rod axis which together form an angle;
a third support rod and a fourth support rod connecting the second engine bracket to a second lower equipment attachment point of the equipment item, the third support rod and the fourth support rod each having a respective rod axis which together form an angle;
a fifth support rod connecting the second engine bracket to a second upper equipment attachment point of the equipment item;
a sixth support rod connecting the second engine bracket to the first lower equipment attachment point.

Such an arrangement of the six support rods makes it possible to fix the six degrees of freedom of the equipment item relative to the engine structure.

The first engine bracket and the second engine bracket may extend generally along the direction of the first axis. The first engine bracket and the second engine bracket may comprise a plurality of openings shaped to prevent the propagation of cracks or splits.

Each equipment attachment point may be arranged at a respective equipment bracket. Alternatively, each first equipment attachment point may be arranged at a first equipment bracket and each second equipment attachment point may be arranged at a second equipment bracket.

The first support rod may be connected to the first engine bracket at a first upper engine attachment point and the second support rod is connected to the first engine bracket at a first lower engine attachment point, the first upper engine attachment point, the first lower engine attachment point, and the first lower equipment attachment point forming a first triangle. The third support rod may be connected to the second engine bracket at a second upper engine attachment point and the fourth support rod is connected to the second engine bracket at a second lower engine attachment point, the second upper engine attachment point, the second lower engine attachment point, and the second lower equipment attachment point forming a second triangle.

The first upper engine attachment point, the first lower engine attachment point, and the first lower equipment attachment point define a first plane, and the second upper engine attachment point, the second lower engine attachment point, and the second lower equipment attachment point define a second plane, the first plane and second plane being secant, preferably forming an angle that is less than or equal to 30°.

Such an arrangement allows preventing substantial movement of the equipment item in the event of failure of the sixth support rod.

The angle between the first plane and second plane may be defined by the acute angle formed between a vector normal to the first plane and a vector normal to the second plane. The first plane may be parallel to a plane comprising the first axis and second axis. A straight line marking the intersection between the first plane and second plane may extend along the direction of the second axis. This thus allows substantial movement of the equipment item along the direction of a third axis perpendicular to the first axis and second axis, in the event of failure of the sixth support rod.

The rod axis of the first support rod and the rod axis of the second support rod may be coplanar in the first plane. The rod axis of the third support rod and the rod axis of the fourth support rod may be coplanar in the second plane.

The first upper engine attachment point and the first lower engine attachment point may be aligned along the direction of the first axis. The second upper engine attachment point may be offset from the second lower engine attachment point along the direction of a third axis perpendicular to the first axis and second axis, preferably by a distance greater than 10 mm, more preferably by a distance equal to 33 mm. The second lower engine attachment point may be closer to the first lower engine attachment point along the direction of the third axis, than is the second upper engine attachment point to the first upper engine attachment point. In other words, the second upper engine attachment point and the second lower engine attachment point are not aligned along the direction of the first axis.

Such an offset contributes to the absorption of forces along the direction of the third axis by the pairs of rods respectively comprising the first support rod and second support rod on the one hand and the third support rod and fourth support rod on the other hand, in the event of failure of the sixth support rod.

The second upper engine attachment point and the second lower engine attachment point may each be spaced apart from the first upper engine attachment point and from the first lower engine attachment point, along the direction of a third axis perpendicular to the first axis and to the second axis, preferably the second upper engine attachment point and the second lower engine attachment point being respectively aligned with the first upper engine attachment point and the first lower engine attachment point along the direction of the third axis.

The second upper equipment attachment point and the second lower equipment attachment point may each be spaced apart from the first upper equipment attachment point and from the first lower equipment attachment point, along the direction of a third axis perpendicular to the first axis and to the second axis, preferably the second upper equipment attachment point and the second lower equipment attachment point being respectively aligned with the first upper equipment attachment point and the first lower equipment attachment point along the direction of the third axis.

The first engine bracket and the second engine bracket may each extend between a first end and a second end along the direction of the first axis, the first engine bracket and the second engine bracket each being fixed to the casing at their respective first end, and the engine structure comprises:
a first connecting rod connected at a first end to the casing and connected at a second end to the second end of the first engine bracket,
a second connecting rod connected at a first end to the casing and connected at a second end to the second end of the second engine bracket.

The second end of the first engine bracket and the second end of the second engine bracket may thus be arranged at a distance from the casing of the engine structure, which makes it possible to further distance the first and second lower engine attachment points from the first and second upper engine attachment points along the direction of the third axis.

The safety rod may be connected to the equipment item or to the engine structure by at least one elastic connection enabling movement between the safety rod and the respective equipment item or engine structure, preferably along the direction of a rod axis along which the safety rod extends.

Compression of the elastic connection allows limited movement between the safety rod and the respective equipment item or engine structure. This allows the safety rod to be mounted while preventing the suspension device from being statically indeterminate and at the same time preventing the safety rod from being subjected to significant movements that could lead to premature wear of said rod. Assembly of the suspension device is also facilitated.

The safety rod may comprise an intermediate body of elongate shape and at least one connecting head at one end of the intermediate body, the connecting head comprising an orifice in which a ball joint is received, the connecting head being interposed between the arms of a clevis of the engine structure or of the equipment item and retained therein by a shaft of the suspension device which passes through the ball joint of the connecting head and through an orifice traversing each arm of the clevis.

The elastic connection may comprise at least one pair of elastic rings tightly fitted respectively into the orifice in one of the arms of the clevis so that the shaft passes through each of the elastic rings, each of the elastic rings further being made of a less rigid material than a material from which the corresponding shaft is made.

Thus, each elastic ring may be deformed (in particular compressive deformation) when the corresponding connecting head exerts a force thereon, thereby allowing limited movement of the attachment head at the safety rod.

Each elastic ring may be made of a material having a low Young's modulus, for example between 0.001 GPa and 0.1 GPa. Each elastic ring may be made of elastomer or rubber, or of a metal foam, a metal mesh or spring, or another compact metal structure having elasticity. Alternatively, the elastic ring may be made of a material having a Young's modulus of less than 10 GPa, and preferably chosen so that the safety rod has a mode of vibration that is outside the vibration range of the engine structure. The safety rod may be made of metal.

Each elastic ring may be secured to the corresponding arm of the clevis, in particular along the direction of the shaft. Each elastic ring may comprise, on each side along the direction of the shaft, an external annular rim for bearing against a lateral face of the corresponding arm of the clevis.

The connecting head may therefore be arranged within the direction of extension of the shaft between the elastic rings.

Each rod (i.e. support rod and safety rod) may comprise an intermediate body of elongate shape. Each rod may comprise a connecting head at each end of the intermediate body. Each connecting head may be assembled to or formed as one piece with the intermediate body. Each connecting head may comprise an orifice and a ball joint received inside the orifice, an inner surface of the associated orifice being capable of serving as a guide for the ball joint.

Each connecting head may be mounted between arms of a clevis. Depending on the end of the rod, the clevis may be formed by the engine structure or by the equipment item. In particular, the engine structure and the equipment item may comprise a clevis at each respective attachment point. Each respective clevis may be formed by one of the engine brackets or by one of the equipment brackets.

Each connecting head may be held between the arms by a respective shaft of the suspension device, which passes through an orifice traversing each arm of the corresponding clevis and through the ball joint. The ball joint may be crimped onto the shaft. The shaft may also be secured to the arms, for example by a nut which engages with a threaded portion of the shaft. A pair of bushings may be fitted tightly into the hole of each arm or into one of the elastic rings where appropriate so that the shaft passes through each of the bushings. The ball joint of the rod may be supported on each side, along the direction of the shaft, against the bushings so as to be immobilized in the direction of extension of the shaft. The connecting head of each rod may thus pivot freely about the axis of extension of the shaft and any axis perpendicular thereto within the limits of the abutments defined by the environment, in particular by the spacing between the arms of the female clevis or where appropriate between the rings of the elastic connection.

Each rod has a respective rod axis. The intermediate body of each rod may extend along the respective rod axis. The rod axis of each rod may pass through the engine attachment point and the corresponding equipment attachment point of the rod.

The shafts for connecting each of the connecting heads of the first support rod, second support rod, third support rod, fourth support rod, fifth support rod, and safety rod may each extend along the direction of the third axis. The shafts for connecting each of the connecting heads of the sixth rod may each extend along the direction of the first axis.

### BRIEF DESCRIPTION OF DRAWINGS

Other features, details and advantages will become apparent upon reading the detailed description below, and upon analyzing the attached drawings, in which:

FIG. 1 represents a schematic view of an assembly comprising a turbomachine engine structure, an equipment item, and a suspension device according to the present description;

FIG. 2 represents a perspective view of the suspension device of FIG. 1;

FIG. 3 represents a partial perspective view of the suspension device of FIG. 2, in particular illustrating a safety rod of the suspension device;

FIG. 4 represents a partial cross-sectional view of the suspension device of FIG. 2; in particular illustrating an attachment system to which one end of a safety rod of the suspension device is connected.

### DESCRIPTION OF EMBODIMENTS

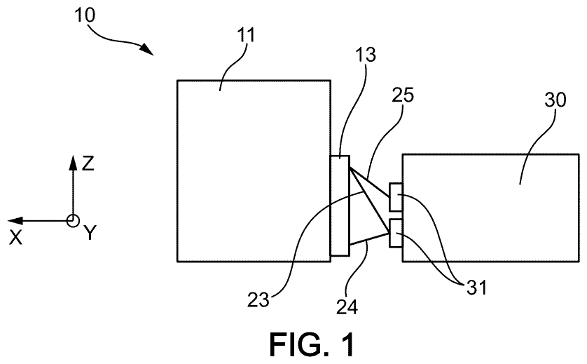

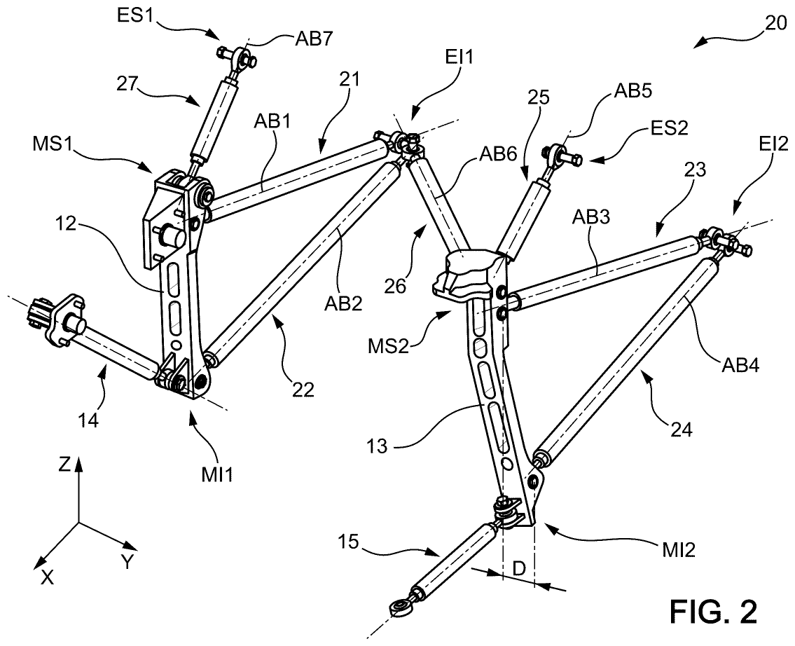

Reference is now made to FIGS. 1 and 2 which represent an assembly comprising an engine structure 10 for a turbomachine and an equipment item 30 suspended from engine structure 10. Engine structure 10 extends along a first axis Z which is a longitudinal axis of the turbomachine, i.e. an axis of rotation of the rotating parts (shafts, compressor(s), turbine(s)) which make up the gas generator of the turbomachine. In the example configuration shown, the first axis Z extends vertically, but an inclination of the longitudinal axis of the turbomachine, of up to 90° relative to the vertical, remains possible. Engine structure 10 here comprises a casing 11, a first engine bracket 12, and a second engine bracket 13. First engine bracket 12 and second engine bracket 13 are intended for the suspension of equipment item 30 as described below. First engine bracket 12 and second engine bracket 13 are each secured to casing 11. Casing 11 may comprise a first part surrounding a propulsion portion of the turbomachine and a second part surrounding a gearbox of the turbomachine. First engine bracket 12 may be fixed to the first part of casing 11 and second engine bracket 13 may be fixed to the second part of casing 11. Equipment item 30 may be for example a heat exchanger. Equipment item 30 may in particular comprise an external body by which equipment item 30 is connected to engine structure 10.

Equipment item 30 is suspended from engine structure 10, being offset along the direction of a second axis X perpendicular to the first axis Z. To do this, the assembly comprises a suspension device 20. The second axis X may correspond to a roll axis of an aircraft on which the assembly is mounted (a helicopter for example). Depending on the movement of the aircraft, the direction of the second axis X may correspond to the forward direction of the aircraft. In that particular case, axis Z may correspond to a yaw axis of the aircraft, its direction, in such case, being coincident with the direction of the Earth's gravity field (i.e. the axis Z is coincident with a vertical axis).

As is more particularly visible in FIG. 2, engine structure 10 comprises a first upper engine attachment point MS1 and a second upper engine attachment point MS2 which are spaced apart from each other at least along the direction of a third axis Y perpendicular to the first axis Z and to the second axis X. First engine bracket 12 and second engine bracket 13 are spaced apart from each other at least along the direction of the third axis Y. It is noteworthy, in the illustrated example, that first upper engine attachment point MS1 and second upper engine attachment point MS2 are aligned along the direction of the third axis Y. Engine structure 10 also comprises a first lower engine attachment point MI1 and a second lower engine attachment point MI2 which are spaced apart from each other at least along the direction of the third axis Y and are respectively distanced from first upper engine attachment point MS1 and from second upper engine attachment point MS2 at least along the direction of the first axis X. It is noteworthy, in the illustrated example, that first lower engine attachment point MI1 and second lower engine attachment point MI2 are aligned along the direction of the third axis Y.

First upper engine attachment point MS1 and first lower engine attachment point MI1 are arranged at first engine bracket 12, and second upper engine attachment point MS2 and second lower engine attachment point MI2 are arranged at second engine bracket 13.

First engine bracket 12 and second engine bracket 13 are each fixed, here by bolting, to casing 11 at a respective first end. Engine structure 10 further comprises, on the one hand, a first connecting rod 14 connected at a first end to casing 11 and connected at a second end of first engine bracket 12, and, on the other hand, a second connecting rod 15 connected at a first end to casing 11 and connected at a second end of second engine bracket 13. The second end of first engine bracket 12 and the second end of second engine bracket 13 are thus arranged at a distance from casing 11 of engine structure 10, which makes it possible to further distance the first and second lower engine attachment points MI1, MI2 from the first and second upper engine attachment points MS1, MS2, along the direction of the third axis Y.

Similarly, equipment item 30 comprises a first upper equipment attachment point ES1 and a second upper equipment attachment point ES2 which are spaced apart from each other at least along the direction of the third axis Y. It is noteworthy, in the illustrated example, that first upper equipment attachment point ES1 and second upper equipment attachment point ES2 are aligned along the direction of the third axis Y. Equipment item 30 also comprises a first lower equipment attachment point EI1 and a second lower equipment attachment point EI2 which are spaced apart from each other at least along the direction of the third axis Y and are respectively distanced from first upper equipment attachment point ES1 and from second upper equipment attachment point ES2 at least along the direction of the first axis Z. It is noteworthy, in the illustrated example, that first lower equipment attachment point EI1 and second lower equipment attachment point EI2 are aligned along the direction of the third axis Y. Each equipment attachment point 30 may be arranged at a respective equipment bracket 31.

Suspension device 20 firstly comprises six support rods connecting equipment item 30 to engine structure 10 in a statically determinate manner. In particular, suspension device 20 comprises:
a first support rod 21 connected at a first end to engine structure 10 at first upper engine attachment point MS1 and connected at a second end to equipment item 30 at first lower equipment attachment point EI1;
a second support rod 22 connected at a first end to engine structure 10 at first lower engine attachment point MI1 and connected at a second end to equipment item 30 at first lower equipment attachment point EI1;
a third support rod 23 connected at a first end to engine structure 10 at second upper engine attachment point MS2 and connected at a second end to equipment item 30 at second lower equipment attachment point EI2;
a fourth support rod 24 connected at a first end to engine structure 10 at second lower engine attachment point MI2 and connected at a second end to equipment item 30 at second lower equipment attachment point EI2;
a fifth support rod 25 connected at a first end to engine structure 10 at second upper engine attachment point MS2 and connected at a second end to equipment item 30 at second upper equipment attachment point ES2;
a sixth support rod 26 connected at a first end to engine structure 10 at second upper engine attachment point MS2 and connected at a second end to equipment item 30 at first lower equipment attachment point EI1.

Such an arrangement thus makes it possible to fix the six degrees of freedom of equipment item 30 relative to engine structure 10.

The device further comprises a safety rod 27 connecting equipment item 30 to engine structure 10. However, safety rod 27 is configured to have a lower mechanical load than the mechanical load of each of the support rods. Thus, in the event of failure of one of the support rods (for example in the event of breakage of one of the support rods), safety rod 27 is then mechanically engaged so that it mechanically participates in the suspension of equipment item 30 from_engine structure 10 while avoiding any substantial movement of equipment item 30 relative to engine structure 10 and avoiding a mechanical overloading of the other support rods. The device therefore has increased safety with redundancy (“fail-safe”). For example, the mechanical stresses exerted on safety rod 27 when it is on standby (i.e. when it is not actively participating in the suspension of equipment item 30) may be less than or equal to 50%, and preferably to 40%, of the mechanical stresses exerted on the support rods.

According to the illustrated example, the safety rod is connected at a first end to engine structure 10 at first upper engine attachment point MS1 and is connected at a second end to equipment item 30 at first upper equipment attachment point ES1.

Furthermore, a first plane passing through first upper engine attachment point MS1, first lower engine attachment point MI1, and first lower equipment attachment point EI1 is defined; and a second plane passing through second upper engine attachment point MS2, second lower engine attachment point MI2, and second lower equipment attachment point EI2 form a second plane. The first plane is parallel to a plane comprising the first axis Z and the second axis X.

Each rod (support rod and safety rod) has a respective rod axis AB1, AB2, AB3, AB4, AB5, AB6, AB7. The rod axis of each rod passes through the engine attachment point and the corresponding equipment attachment point 30 of the rod. The rod axis of each of the rods extends in a direction comprising at least one component in the direction of the second axis X. Also, here, rod axis AB1 of first support rod 21 and rod axis AB2 of second support rod 22 are coplanar in the first plane. Similarly, here, rod axis AB3 of third support rod 23 and rod axis AB4 of fourth support rod 24 are coplanar in the second plane.

In particular:
the direction of rod axis AB1 of first support rod 21 comprises a component in the direction of the first axis Z and a component in the direction of the second axis X; i.e. it does not comprise a component in the direction of the third axis Y;
the direction of rod axis AB2 of second support rod 22 comprises a component in the direction of the first axis Z and a component in the direction of the second axis X; i.e. it does not comprise a component in the direction of the third axis Y;
the direction of rod axis AB3 of third support rod 23 comprises a component in the direction of the first axis Z and a component in the direction of the second axis X; i.e. it does not comprise a component in the direction of the third axis Y;
the direction of rod axis AB4 of fourth support rod 24 comprises a component in the direction of the first axis Z, a component in the direction of the second axis X, and a component in the direction of the third axis Y;
the direction of rod axis AB5 of fifth support rod 24 comprises a component in the direction of the first axis Z and a component in the direction of the second axis X;
the direction of rod axis AB6 of second support rod 26 comprises a component in the direction of the second axis X, a component in the direction of the third axis Y, and preferably a component in the direction of the first axis Z;
the direction of rod axis AB7 of safety rod 27 comprises a component in the direction of the first axis Z and a component in the direction of the second axis X.

Thus, rod axis AB1 of first support rod 21 and rod axis AB2 of second support rod 22 form an angle (non-zero). In other words, rod axis AB1 of first support rod 21 and rod axis AB2 of second support rod 22 are coplanar and are not parallel to each other. Similarly, rod axis AB3 of third support rod 23 and rod axis AB4 of fourth support rod 24 form an angle (non-zero), i.e. rod axis AB3 of third support rod 23 and rod axis AB4 of fourth support rod 24 are coplanar and are not parallel to each other.

According to another aspect of the present description, the first plane and the second plane are secant. A straight line formed by the intersection of the first plane and second plane extends here along the direction of the second axis X. Such an arrangement makes it possible to avoid a substantial movement of equipment item 30 along the direction of the third Y in the event of failure (for example in the event of breakage) of sixth support rod 26.

In particular, first upper engine attachment point MS1 and first lower engine attachment point MI1 are aligned along the direction of the first axis Z, and second lower engine attachment point MI2 is at a distance from second upper engine attachment point MS2 along the direction of the third axis Y, towards first upper engine attachment point MS1 and first lower engine attachment point MI1, here by a distance D equal to 33 mm. Alternatively, distance D may be between 28 mm and 50 mm. Such an offset contributes to the absorption of forces along the direction of the third axis Y by the pairs of rods respectively comprising first support rod 21 and second support rod 22 on the one hand and third support rod 23 and fourth support rod 24 on the other hand, in the event of failure of sixth support rod 26.

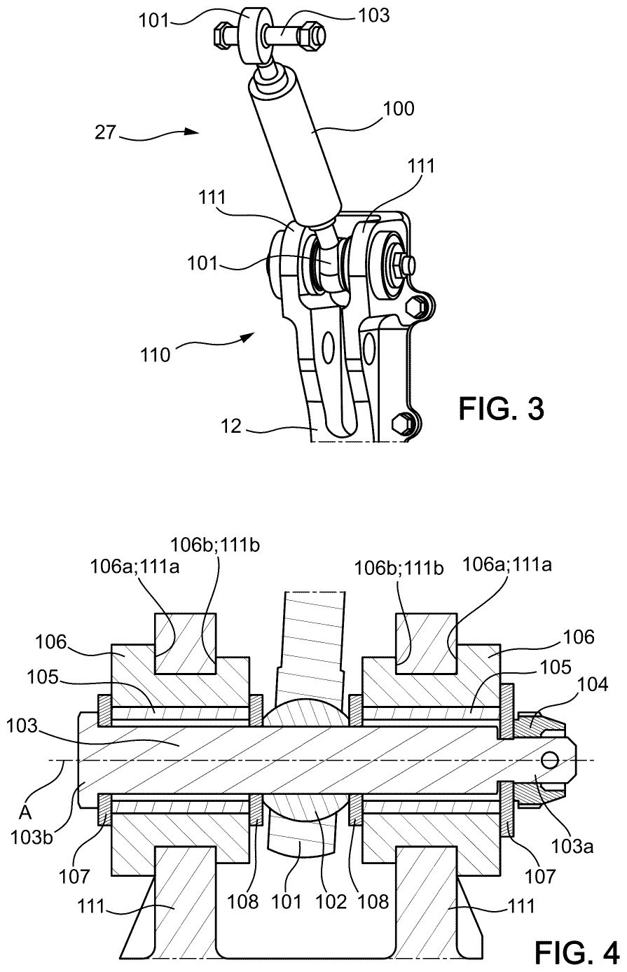

Reference is now made to FIGS. 3 and 4 which show safety rod 27 in more detail. In the following, unless otherwise specified, each of the rods is described with reference to FIGS. 3 and 4.

Each rod (i.e. support rod and safety rod) comprises an intermediate body 100 of elongate shape. Intermediate body 100 of each extends along the respective rod axis of the rod. Each rod comprises a connecting head 101 at each end of intermediate body 100. Each connecting head 101 is assembled to or formed as one piece with intermediate body 100.

Each connecting head 101 comprises an orifice and a ball joint 102 received inside the orifice, an inner surface of the associated orifice being capable of serving as a guide for ball joint 102. Furthermore, each connecting head 101 is mounted between arms 111 of a clevis 110. Depending on the end of the rod, clevis 110 may be formed at engine structure 10 or at equipment item 30. In particular, engine structure 10 and equipment item 30 comprise a clevis 110 at each respective attachment point. Each respective clevis 110 may be formed by one of engine brackets 12, 13 or by one of equipment brackets 31.

Each connecting head 101 is held between arms 111 by a respective shaft 103 which extends along a respective shaft axis A. Shaft 103 traverses an orifice through each arm 111 of the corresponding clevis 110 and through ball joint 102. Ball joint 102 may be crimped onto shaft 103. Furthermore, shaft 103 is secured to arms 111, for example by a nut 104 which engages with a threaded portion 103a of shaft 103.

Shafts 103 for connecting each of connecting heads 101 of first support rod 21, second support rod 22, third support rod 23, fourth support rod 24, fifth support rod 25, and safety rod 27 each extend along the direction of the third axis Y. Shafts 103 for connecting each of connecting heads 101 of sixth support rod 26 each extend along the direction of the first axis Z.

A pair of bushings 105 may be tightly fitted into the orifice of each arm 111 so as to be mounted around shaft 103. Ball joint 102 of the rod may be supported on each side, along the direction of shaft 103, against bushings 105 so as to be immobilized in the direction of extension of shaft 103. Connecting head 101 of each rod may thus pivot freely about the axis of extension A of shaft 103 and any axis perpendicular thereto, within the limits of the abutments defined by the environment, in particular by the spacing between arms 111 of the female clevis.

It is noteworthy, as shown in FIGS. 3 and 4, that safety rod 27 is connected to engine structure 10 by an elastic connection which allows limited movement of safety rod 27 relative to engine structure 10, in particular along the direction of rod axis AB7 of safety rod 27. This makes it easier to mount safety rod 27 while preventing suspension device 20 from being statically indeterminate and at the same time preventing safety rod 27 from being subjected to significant movements during the operation of the turbomachine, which could lead to premature wear.

The elastic connection comprises a pair of elastic rings 106 tightly fitted into the respective orifice in each arm 111 of clevis 110 on the engine structure 10 side, so as to be mounted around the corresponding shaft 103. In other words, each elastic ring is interposed between shaft 103 and the edge of the orifice traversing the corresponding arm. Here, in this case, each of bushings 105 is tightly fitted into one of elastic rings 106. Each bushing 105 is therefore interposed between the corresponding ring 105 and shaft 103. Also, connecting head 101 is arranged, along the direction of extension of shaft 103, between elastic rings 106. Thus, the abutments restricting connecting head 101 are defined here by the elastic rings.

Each of elastic rings 106 is further made of a less rigid material than a material from which the corresponding shaft 103 is made. Each elastic ring 106 may be made of a material having a low Young's modulus, for example between 0.001 GPa and 0.1 GPa. For example, each elastic ring 106 may be made of elastomer or rubber. According to other examples, each elastic ring 106 may be made of a metal foam, a metal mesh or spring, or another compact metal structure having elasticity. In comparison, safety rod 27 and/or the corresponding shaft 103 may each be made of metal.

Thus, each elastic ring 106 may undergo compressive deformation when the corresponding connecting head 101 exerts a force thereon, directly or via the shaft, which allows movement of the attachment head at safety rod 27.

In addition, each elastic ring 106 is secured to the corresponding arm 111 of clevis 110, in particular along the direction of shaft 103. Each elastic ring 106 here comprises, on each side along the direction of shaft 103, an external annular rim 106a, 106b for bearing against a lateral face 111a, 111b of the corresponding arm 111 of clevis 110.

Optionally, a first pair of washers 107 may be mounted, respectively, between a head 103b of shaft 103 and one of elastic rings 106, and between nut 104 and the other of elastic rings 106. Again optionally, another pair of washers 108 may be mounted between each elastic ring and the ball joint 102 in order to grip the ball joint along the direction of shaft 103.

1. An assembly comprising a turbomachine engine structure (10) extending along a first axis (Z), at least one equipment item (30), and a suspension device (20) for suspending the equipment item (30) from the engine structure (10) while being offset along the direction of at least a second axis (X) perpendicular to the first axis (Z), the suspension device (20) comprising:
at least six support rods (21; 22; 23; 24; 25; 26) connecting the equipment item (30) to the engine structure (10) in a statically determinate manner;
at least one safety rod (27) connecting the equipment item (30) to the engine structure (10), the safety rod (27) being configured to have a lower mechanical load than a mechanical load of each of the support rods (21; 22; 23; 24; 25; 26).

2. The assembly according to claim 1, wherein the engine structure (10) comprises at least a casing (11), a first engine bracket (12), and a second engine bracket (13), the first engine bracket (12) and the second engine bracket (13) each being connected to the casing (11), the safety rod (27) connecting the first engine bracket (12) to a first upper equipment attachment point (ES1) of the equipment item (30), and wherein said at least six support rods (21; 22; 23; 24; 25; 26) comprise:
a first support rod (21) and a second support rod (22) connecting the first engine bracket (12) to a first lower equipment attachment point (EI1) of the equipment item (30), the first support rod (21) and the second support rod (22) each having a respective rod axis (AB1; AB2) which together form an angle;
a third support rod (23) and a fourth support rod (24) connecting the second engine bracket (13) to a second lower equipment attachment point (EI2) of the equipment item (30), the third support rod (23) and the fourth support rod (24) each having a respective rod axis (AB3; AB4) which together form an angle;
a fifth support rod (25) connecting the second engine bracket (13) to a second upper equipment attachment point (ES2) of the equipment item (30);
a sixth support rod (26) connecting the second engine bracket (13) to the first lower equipment attachment point (EI1).

3. The assembly according to claim 2, wherein the first support rod (21) is connected to the first engine bracket (12) at a first upper engine attachment point (MS1) and the second support rod (22) is connected to the first engine bracket (12) at a first lower engine attachment point (MI1), the first upper engine attachment point (MS1), the first lower engine attachment point (MI1), and the first lower equipment attachment point (EI1) forming a first triangle, and wherein the third support rod (23) is connected to the second engine bracket (13) at a second upper engine attachment point (MS2) and the fourth support rod (24) is connected to the second engine bracket (13) at a second lower engine attachment point (MI2), the second upper engine attachment point (MS2), the second lower engine attachment point (MI2), and the second lower equipment attachment point (EI2) forming a second triangle.

4. The assembly according to claim 3, wherein the first upper engine attachment point (MS1), the first lower engine attachment point (MI1), and the first lower equipment attachment point (EI1) define a first plane, and the second upper engine attachment point (MS2), the second lower engine attachment point (MI2), and the second lower equipment attachment point (EI2) define a second plane, the first plane and second plane being secant, forming an angle that is less than or equal to 30°.

5. The assembly according to claim 3, or 4, wherein the first upper engine attachment point (MS1) and the first lower engine attachment point (MI1) are aligned along the direction of the first axis (Z), and the second lower engine attachment point (MI2) is offset from the second upper engine attachment point (MS2) along the direction of a third axis (Y) perpendicular to the first axis (Z) and second axis (X).

6. The assembly according to claim 3, wherein the second upper engine attachment point (MS2) and the second lower engine attachment point (MI2) are each spaced apart from the first upper engine attachment point (MS1) and from the first lower engine attachment point (MI1), along the direction of a third axis (Y) perpendicular to the first axis (Z) and to the second axis (X).

7. The assembly according to claim 2, wherein the second upper equipment attachment point (ES2) and the second lower equipment attachment point (EI2) are each spaced apart from the first upper equipment attachment point (ES1) and from the first lower equipment attachment point (EI1), along the direction of a third axis (Y) perpendicular to the first axis (Z) and to the second axis (X).

8. The assembly according to claim 2, wherein the first engine bracket (12) and the second engine bracket (13) each extend between a first end and a second end along the direction of the first axis (Z), the first engine bracket (12) and the second engine bracket (13) each being fixed to the casing (11) at their respective first end, and wherein the engine structure (10) comprises:
a first connecting rod (14) connected at a first end to the casing (11) and connected at a second end to the second end of the first engine bracket (12),
a second connecting rod (15) connected at a first end to the casing (11) and connected at a second end to the second end of the second engine bracket (13).

9. The assembly according to claim 1, wherein the safety rod (27) is connected to the equipment item (30) or to the engine structure (10) by at least one elastic connection enabling movement between the safety rod (27) and the respective equipment item (30) or engine structure (10).

10. The assembly according to claim 9, wherein the safety rod (27) comprises an intermediate body (100) of elongate shape and at least one connecting head (101) at one end of the intermediate body (100), the connecting head (101) comprising an orifice in which a ball joint (102) is received, the connecting head (101) being interposed between arms (111) of a clevis (110) of the engine structure (10) or of the equipment item (30) and retained therein by a shaft (103) of the suspension device (20) which passes through the ball joint (102) of the connecting head (101) and through an orifice traversing each arm (111) of the clevis (110), and
wherein the elastic connection comprises at least one pair of elastic rings (106), each of the elastic rings (106) being tightly fitted into the orifice of one of the arms (111) of the clevis (110) so as to be traversed by the shaft (103), and further being made of a less rigid material than a material from which the corresponding shaft (103) is made.

11. The assembly according to claim 10, wherein each elastic ring (106) may be made of a material having a Young's modulus that is, for example, between 0.001 GPa and 0.1 GPa.

12. The assembly according to claim 10, wherein each elastic ring (106) is made of elastomer or rubber.

13. The assembly according to claim 10, wherein each elastic ring (106) is secured to the corresponding arm (111) of the clevis (110) along the direction of the shaft.

14. The assembly according to claim 13, wherein each elastic ring (106) comprises, on each side along the direction of the shaft, an external annular rim (106a; 106b) for bearing against a lateral face (111a; 111b) of the corresponding arm (111) of the clevis (110).

15. The assembly according to claim 5, wherein the second lower engine attachment point (MI2) is offset from the second upper engine attachment point (MS2) by a distance greater than 10 mm.

16. The assembly of claim 15, wherein the distance is between 28 mm and 50 mm.

17. The assembly of claim 6, wherein the second upper engine attachment point (MS2) and the second lower engine attachment point (MI2) being respectively aligned with the first upper engine attachment point (MS1) and the first lower engine attachment point (MI1) along the direction of the third axis (Y).

18. The assembly of claim 7, wherein the second upper equipment attachment point (ES2) and the second lower equipment attachment point (EI2) being respectively aligned with the first upper equipment attachment point (ES1) and the first lower equipment attachment point (EI1) along the direction of the third axis (Y).
